(19) United States
(12) Patent Application Publication
(10) Pub. No.: US 2005/0031151 A1
(43) Pub. Date: Feb. 10, 2005

(54) Speaker with adjustable voice coil impedance

(76) Inventor: Louis Melillo, Columbus, IN (US)

Correspondence Address: Maginot, Moore & Beck;Bank One Tower, Suite 3000, 111 Monument Circle, Indianapolis, IN, 46204, US

(21) Appl. No.: 10/836,814

(22) Filed: Apr. 30, 2004

Related U.S. Application Data
(60) Provisional application No. 60/467,209, filed on Apr. 30, 2003.

(51) Int. Cl. H04R 1/00; H04R 9/06; H04R 11/02

(52) U.S. Cl. 381/401; 381/414; 381/407

(57) ABSTRACT

A loudspeaker includes a diaphragm, a magnetic core, and a plurality of coils in a flux communicating relationship with the magnetic core. The plurality of coils are connected to a switching terminal, and the switch terminal is configurable to selectively connect the plurality of coils in a plurality of configurations. Each of the plurality of configurations has one of a plurality of impedances.

This application claims the benefit of U.S. Provisional Patent Application Ser. No. 60/467,209, entitled “Speaker With Adjustable Voice Coil Impedance”, which is incorporated herein by reference.

### FIELD OF THE INVENTION

The present invention relates generally to loudspeakers for use in audio systems.

### BACKGROUND OF THE INVENTION

Loudspeakers are available in a wide variety of sizes and audio capabilities for a wide variety of applications. Even among consumer audio equipment, loudspeakers can range from a few inches in diameter to in excess of twelve inches. The configuration of audio systems in which loudspeakers are used also vary significantly in both power and voltage levels.

By way of example, a typical home audio amplifier in a compact configuration may generate anywhere from 0.1 volts to 20 volts maximum, with output power ranging from a few watts to more than 100 watts. The speakers used in such configurations range widely in size and power handling capacity, but typically have low impedance, for example, 4 or 8 ohms. While such configurations are adequate for most self-contained or at least proximal sound system configurations, the use of low voltage amplifier signals is not always adequate for distributed systems, such as commercial systems or house-wide sound systems. In particular, distributed systems often involve significant lengths of speaker wire, which can result in high I²R loss. I²R loss at low voltage signals can significantly degrade the sound quality.

To reduce this degradation in sound quality, distributed commercial and home sound systems typically generate higher voltage output signals. Common output signal voltages in such systems can, for example, be as much as 70 volts or 100 volts. Such output signals require higher impedance speaker systems.

To address this issue, commercial system installers have employed transformers to step down the voltage at the loudspeaker to allow for the use of 4 or 8 ohm loudspeakers with 70 or 100 volt systems. The use of transformers allow commercial systems to retain the efficiencies of distributing audio signals at high voltage over long wire runs while further allowing for the use of ordinary low impedance speakers.

In many cases, it is desirable to have different sound volumes in different parts of a distributed audio system. To allow for volume variance from speaker to speaker, the step down transformers are often provided with multiple taps. Each tap provides a different effective turns ratio, and therefore provides a different output power level to the speaker voice coil. By selecting of taps on the step down transformers, the speakers of a distributed audio system may be adjusted to any of a number of distinct volume levels.

A drawback to the use of transformers is the associated cost and inconvenience. Transformers for a full range speaker or high power subwoofer can be relatively large and require a heavy core as well as coils that add cost in manufacture, transport, and installation. Such transformers can result in nearly 25% of the speaker system cost.

There exists a need, therefore, for a loudspeaker arrangement that is suitable for distributed audio systems that reduces or eliminates the drawbacks of using transformers.

### SUMMARY OF THE INVENTION

The present invention addresses the above needs, as well as others, by providing a voice coil arrangement for a loudspeaker having multiple coils that are selectably connectable in a variety of configurations, each configuration generating one of a plurality of impedances. The plurality of impedances can allow each speaker to have one of a plurality of volume levels in a distributed system, or may be used to allow the speaker to be configured as either a high impedance speaker or a low (4 or 8 ohm) impedance speaker.

A distributed system according to one aspect of the present invention employs multiple speakers having relatively high impedances to eliminate the need for a transformer.

A first embodiment of the invention is a loudspeaker that includes a diaphragm, a magnetic core, and a plurality of coils in a flux communicating relationship with the magnetic core. The plurality of coils are connected to a terminal, and the terminal manually is configurable to selectively connect the plurality of coils in a plurality of configurations, each of the plurality of configurations having one of a plurality of impedances.

The number of coils may be two or more, and the configurations preferably include at least some series connections of coils and at least some parallel connections of coils.

One alternative embodiment is a two-way speaker that includes a first loudspeaker and a tweeter. Because tweeters have relatively small voice coils, it may be difficult to employ multiple high impedance voice coils to enable direct connection to a 70 or 100 volt line. Thus, the two-way speaker may instead include a loudspeaker having a plurality of selectably connectable coils while the tweeter has a single coil and a small transformer. Even though a transformer is still required, the transformer is substantially smaller, requires a far smaller core, and is consequently far less expensive than the step down transformer that would be required for non-tweeter loudspeaker.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic block diagram of distributed audio system according to one aspect of the invention;

FIG. 2 shows a schematic block diagram of an exemplary loudspeaker that may be used in the distributed audio system of FIG. 1;

FIG. 2a shows a fragmentary cutaway section of the voice coil arrangement, core and bobbin of the loudspeaker of FIG. 2;

FIG. 3 shows a schematic diagram of an alternative configuration of a voice coil arrangement that may be used in a loudspeaker according to the present invention; and

FIGS. 4a, 4b, and 4c show partial schematic diagrams of the voice coil arrangement of FIG. 3;

FIG. 5 shows an exemplary speaker assembly according to one aspect of the invention.

### DETAILED DESCRIPTION

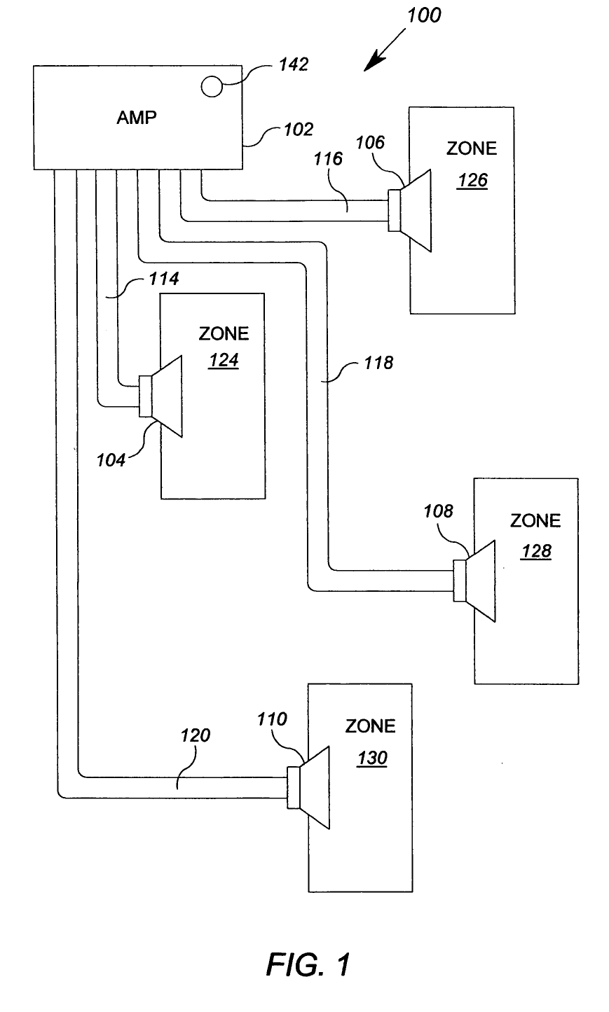

FIG. 1 shows an exemplary distributed audio system 100 according to one aspect of the invention. The distributed audio system includes an amplifier 102, four speakers 104, 106, 108, and 110, and four corresponding conductor pairs 114, 116, 118 and 120. Each of the conductor pairs 114, 116, 118 and 120 transmits electrical audio signals from the amplifier 102 to each corresponding speaker 104, 106, 108 and 120.

The four speakers 104, 106, 108 and 110 are distributed throughout a building or facility, not shown. To this end, each speaker is located in a room or area of the building, referred to herein simply as a “zone” of the building. In the exemplary embodiment described herein, the speaker 104 is configured to provide sounded in zone 124, the speaker 106 is configured to provide sounded in zone 126, the speaker 108 is configured to provide sounded in zone 128, and the speaker 110 is configured to provide sound in zone 130. It will be appreciated that the facility may have any number of speakers in any number of zones. Some zones may have multiple speakers, some zones may have none. The exact configuration of zones and speakers in FIG. 1 is provided by way of illustrative example only.

Each of the conductor pairs 114, 116, 118 and 120 is physically run over a specific path between the amplifier 102 and the respective speaker 104, 106, 108 and 110. The path of each conductor pairs 114, 116, 118 and 120 has a geometry defined at least in part by the conduits and other open spaces in the building, not shown, that are available to provide a continuous path from amplifier and speaker. One advantage of some embodiments of the invention is that additional length of speaker conductors that are necessitated by the building structure can be compensated for by adjusting the speaker output level as will be described below.

The amplifier 102 is an audio amplifier capable of generating a 70 volt audio electrical signal to a plurality of speakers. Such amplifiers are well known in the art, and have most common application in retail establishments, professional offices and the like. Such amplifiers may also be used in residences that have stereo sound wired throughout the residence. The amplifier 102 typically has at least one master volume control 142 that is capable of altering the output power of the audio electrical signals provided to the speakers 104, 106, 108 and 110. In some embodiments of the invention, the amplifier 102 will include multiple volume controls 142, each controlling a bank of speakers.

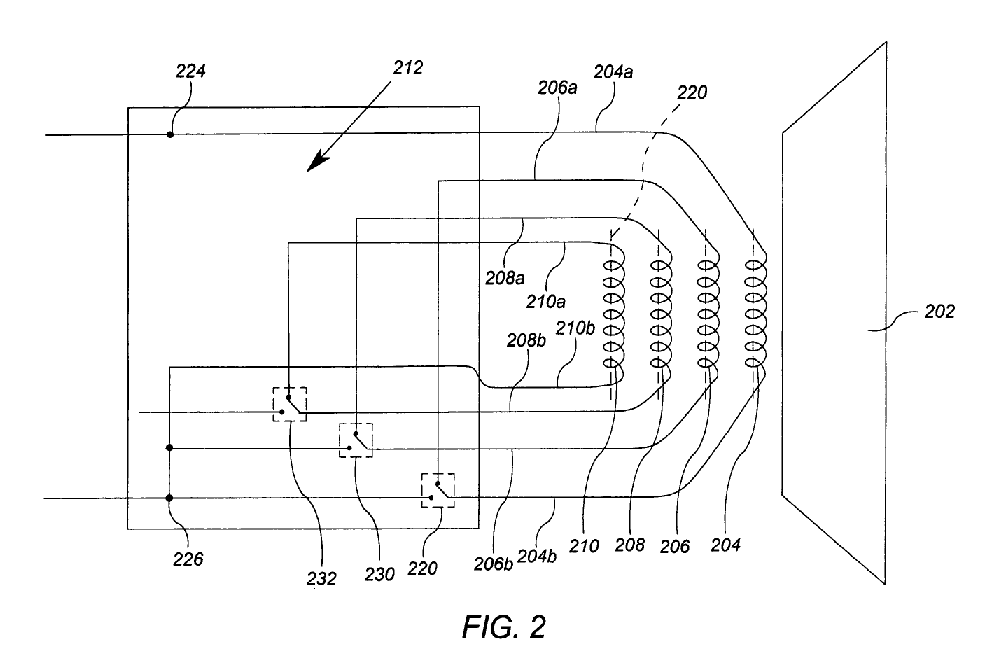

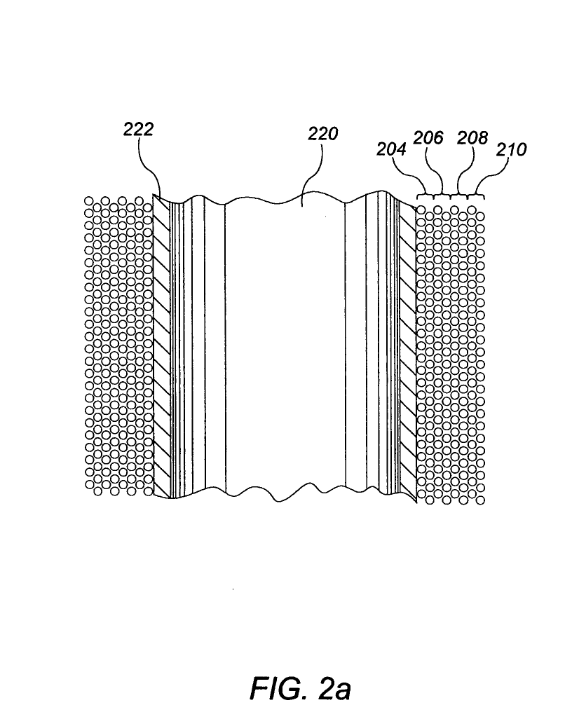

Each of the speakers 104, 106, 108 and 110 has the same basic general design. In general, each of the speakers 104, 106, 108 and 110 includes a plurality of voice coils, not shown in FIG. 1. The plurality of voice coils of each speaker 104, 106, 108 and 110 may be manually configured in a variety of ways to produce a plurality of speaker impedances. Further detail regarding an exemplary embodiment of a speaker that may be used as the speakers 104, 106, 108 and 110 is provided below in connection with FIG. 2.

In the exemplary embodiment described herein, the voice coils of each of the speakers 104, 106, 108 and 110 are manually configurable to have an impedance of 125 ohms, 250 ohms, 375 ohms, and 500 ohms. In a preferred implementation, the system 100 is set up such that different speakers may have different impedances in order to provide various levels of relative sound volume in each of the zones 124, 126, 128, and 130.

In particular, in many distributed systems, it is desirable to have different sound levels in different zones of the facility. For example, in a doctors' office, it may be desirable to have the audio volume of the sound system relatively louder in the lobby than in the examination and consultation rooms. In a residence, it may be desirable to have the audio volume louder in the kitchen than in the dining room. Thus, in the embodiment described herein, it may be desirable to have zones 126, 128 and 130 at a relatively lower volume than the volume in zone 124.

In such a case, the voice coils of the speaker 104 (in zone 124) are configured to have a lower impedance than the voice coils of the speakers 106, 108 and 110 (in zones 126, 128 and 130, respectively). By way of example, the voice coils of speaker 104 are configured to have an impedance of 250 ohms while the voice coils of the speakers 106, 108 and 110 are configured to have an impedance of 500 ohms. As a consequence, the volume in zones 126, 128 and 130 will be generally greater than the volume in zone 124. It will be appreciated, however, that the volume control 142 on the amplifier 102 operates to raise or lower the volume of all the speakers 124, 126, 128 and 130 as a group. Regardless of the setting of the volume control 142, however, the volume output by the speaker 104 will generally always be somewhat greater than the volume output by the speaker 106, 108 and 110.

The above described embodiment allows for a distributed audio system with speakers in plurality of zones, each speaker adjustable to have a different output level by selectively connecting a plurality of coils in a configuration having a select impedance level. As a consequence, a single speaker design may be used in different zones having different relative volume or output power needs. Moreover, such speaker design may be used in a distributed audio system that employs high voltage (about 70-100 volts) output signals without require transformers.

FIG. 2 shows an exemplary speaker 200 in accordance with one aspect of the invention. The speaker 200 may be used as any and all of the speakers 104, 106, 108 and 110 of FIG. 1. The speaker 200 is shown in schematic form in FIG. 2.

The speaker 200 includes a diaphragm 202, a first voice coil 204, a second voice coil 206, a third voice coil 208, a fourth voice coil 210, and a switchable terminal 212. The switchable terminal 212 further includes first, second and third switches 228, 230 and 232 respectively. The speaker 200 further includes a magnetic core 220.

The voice coils 204, 206, 208 and 210 are disposed in about the core 220 using ordinary methods. One suitable method of winding the voice coils about the 220 is illustrated in FIG. 2a. In particular, FIG. 2a shows a fragmentary cross section of an exemplary winding of the voice coils 204, 206, 208 and 210 about the core 220. The voice coils 204, 206, 208 and 210 are wound about a bobbin 222, which is known in the art to be disposed about at least a portion of the magnetic core 220. The voice coils 204, 206, 208 and 210 are wound around the bobbin 222 in double rows, starting with two rows of the coil 204, then two rows of the coil 206, and so forth. The precise layout of the voice coils 204, 206, 208 and 210, however, will largely be matter of design choice, and infinite variations exist. The voice coils 204, 206, 208 and 210 may each be suitably two-layer voice coils, as shown in FIG. 2a, or single layer voice coils as is known in the art. Instead of rows of each coil, the coils may be interleaved such that each row of wire has parts of all of the coils.

Regardless of the particular implementation, the voice coils 204, 206, 208 and 210 are all disposed in a voice coil relationship with the magnetic core elements of the speaker. In other words, each of the voice coils 204, 206, 208 and 210 is configured to cooperate with the magnetic core 220 and the diaphragm 202 (see FIG. 2) to cause movement of the diaphragm responsive to electrical audio signals propagated through each voice coil.

Referring again to FIG. 2 specifically, each of the voice coils 204, 206, 208 and 210 is a 125 ohms voice coil. The voice coil 204 includes first and second leads 204a, 204b, respectively. Similarly, the voice coil 206 includes first and second leads 206a, 206b, respectively, the voice coil 208 includes first and second leads 208a, 208b, respectively, and the voice coil 210 includes first and second leads 210a, 210b, respectively.

The first lead 204a of the first coil 204 is operably coupled to an input terminal jack 224 of the switchable terminal 202. The input jack 224 is operably coupled to one conductor of a 70 volt distributed audio system output conductor pair. The second lead 204b is switchably connected via switch 228 to either another input jack 226 or the first lead 206a of the coil 206. The input jack 226 is operably coupled to the other conductor of the 70 volt distributed audio system output conductor pair. The second lead 206b is switchably connected via switch 230 to either the input jack 226 or the first lead 208a of the coil 208. The second lead 208b is switchably connected via switch 230 to either the input jack 226 or the first lead 210a of the coil 210. The second lead 210b of the coil 210 is connected to the other input jack 226.

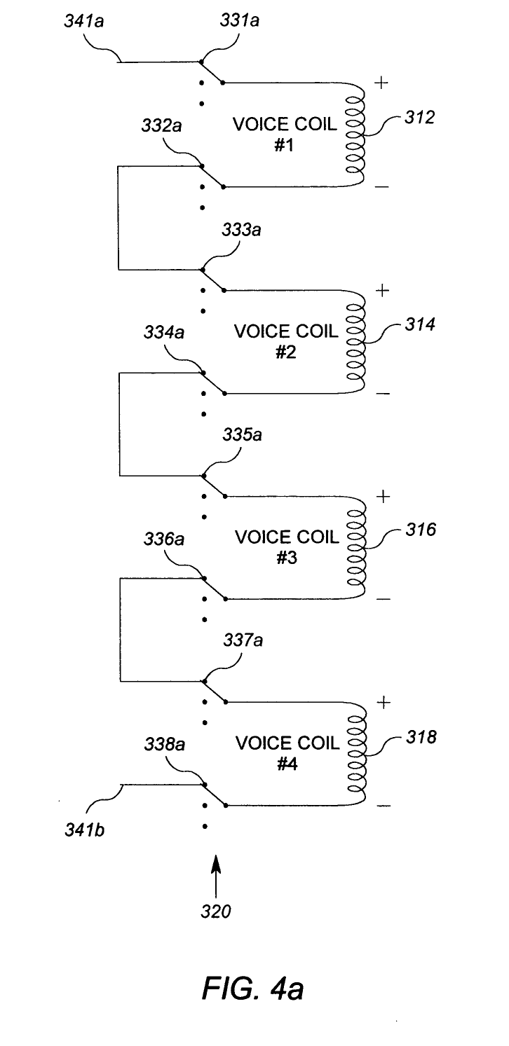

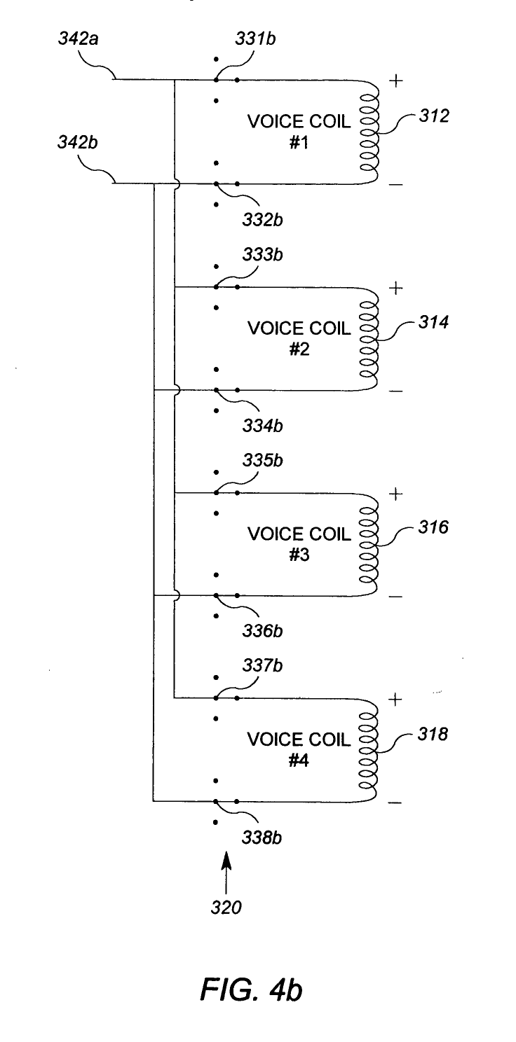

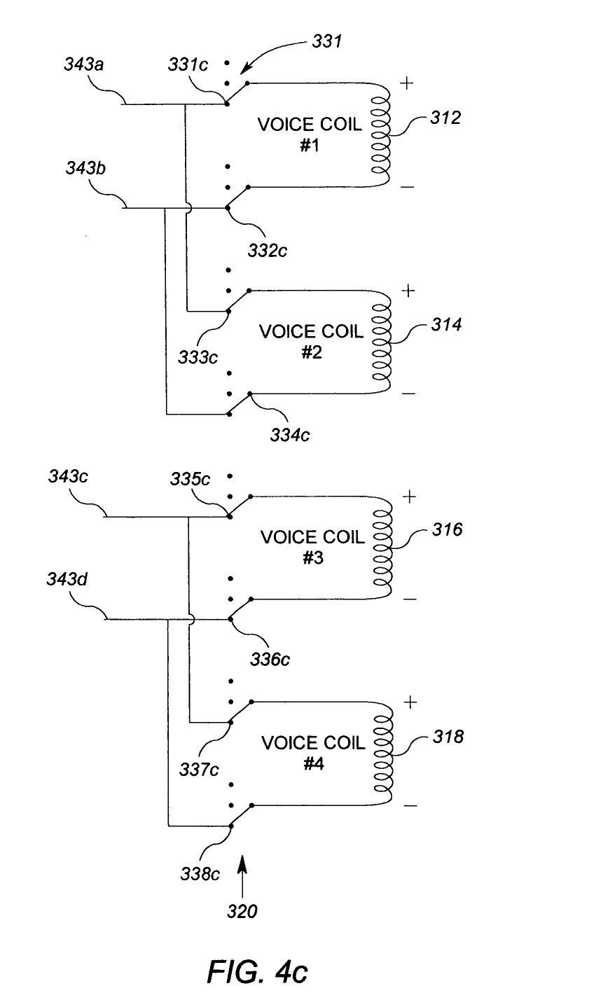

As a consequence, the switches 228, 230 and 232 may be used to selectively connect one, two, three or all four of the coils 204, 206, 208 and 210 in series. It is noted that the terminal 212 should be supported on the speaker structure that includes the diaphragm, the voice coil and the magnet. FIG. 4, discussed further below, shows one of a number of configurations the speaker structure that includes a terminal for allowing manual configuration of a plurality of voice coils. The terminal 212 may use a single rotary mechanical switch to carry out the switch function of the switches 228, 230 and 232. Alternatively, separate toggle switches may be used, or ever jumper wires or devices.

In operation, if the speaker 200 is intended to be in a position where a relatively high volume is desired, then all of the switches 228, 230 and 232 are opened, thereby providing only a single 125 ohms impedance voice coil. If a moderately high volume is desired, then only the switch 228 may be closed to provide two 125 ohms impedance voice coils in series having a total impedance of 250 ohms. If low volume is desired, then all of the switches may be closed, providing four series 125 ohms impedance voice coils having a total impedance of 500 ohms.

Accordingly, the variable volume capability from zone to zone in a distributed audio system may be accomplished without large transformers.

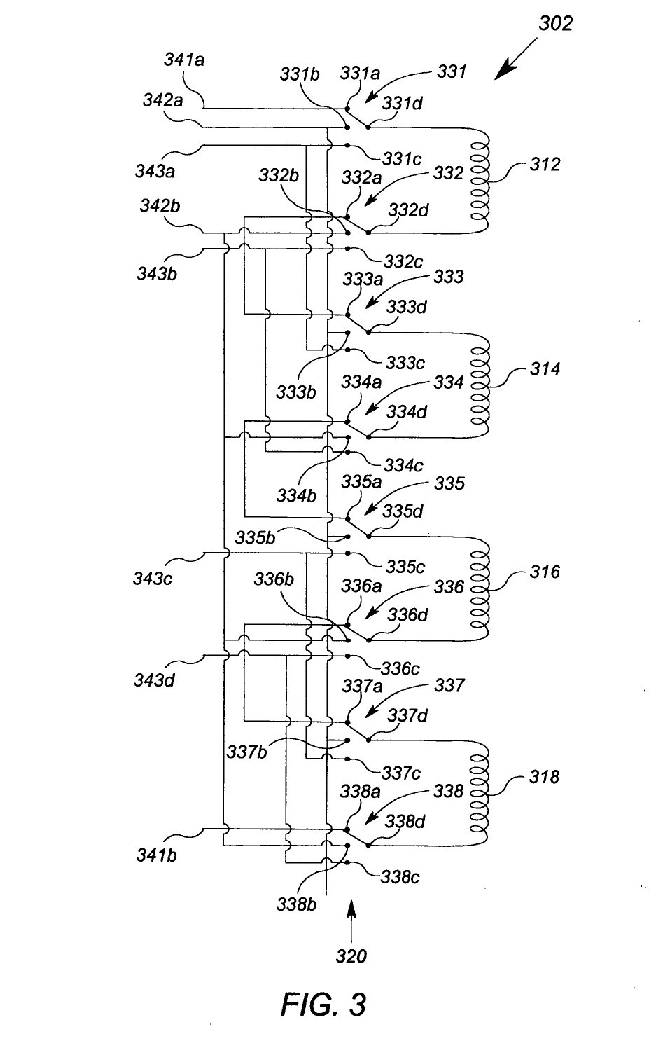

FIG. 3 shows a schematic diagram of an alternative embodiment of the invention that may be used as a voice coil arrangement 302 for a subwoofer. In general, the voice coil arrangement 302 as shown in FIG. 3 includes only the voice coil and switchable terminal elements of the subwoofer. The remaining elements of the subwoofer, including the cone, frame, magnetic core, bobbin, and other parts normally associated with speakers, may readily be selected and constructed by those of ordinary skill in the art. As is known in the art, a subwoofer is a speaker designed for primarily for producing sound in the lower audible and in some cases sub-audible range, for example, from about 25 Hz to 150 Hz.

In general, the voice coil arrangement 302 is designed to facilitate use of the subwoofer in three different amplifier system configurations. The first configuration of the voice coil arrangement 302, discussed below in connection with FIG. 4a, is configured to accommodate a 70 or 100 volt distributed audio system. The second configuration, discussed below in connection with shown in FIG. 4b, is configured as a monaural 4 ohms subwoofer for a normal consumer stereo system (well below 50 volts). The third configuration, discussed below in connection with FIG. 4c, is configured as a stereo 8 ohm per side subwoofer for a normal consumer stereo.

The voice coil arrangement 302 in general includes four 16 ohms voice coils 312, 314, 316 and 318, a three position, eight element switch arrangement 320, and an interconnection circuit 321. The four voice coils 312, 314, 316 and 318 may be wound in a manner similar to any of those described above in connection with the embodiment if FIGS. 2 and 2a.

The switch arrangement 320 includes eight switching elements 331, 332, 333, 334, 335, 336, 337 and 338. Each switching element is switched in unison by, for example, a hand actuator, not shown, but which would be known to one of ordinary skill in the art. The switching elements 331, 332, . . . 338 may be mechanically coupled to switch in unison between three positions. To this end, the switch 320 may be in the form of a rotary switch having eight, axially aligned, three position switching elements. In other embodiments, other switching elements such as electrically coupled banks of relays or even semiconductors switches may be used.

The first switch 331 has three input contacts 331a, 331b, 331c and an output contact 331d, the second switch 332 has three input contacts 332a, 332b, 332c and an output contact 332d, the third switch 333 has three input contacts 333a, 333b, 333c and an output contact 333d, and so forth. Accordingly, there are a total of twenty-four input contacts and eight output contacts.

The interconnection circuit 321 includes a set of connectors 341a, 341b, 342a, 342b, 343a, 343b, 343c and 343d. The connectors 341a, 341b, 342a, 342b, 343a, 343b, 343c and 343d are mounted to a speaker enclosure, not shown, and may suitably constitute screw connector or any standard terminal for connecting speaker conductors. The connectors 341a, 341b, 342a, 342b, 343a, 343b, 343c and 343d are connected to various input contacts of the switch 320 as will be discussed below. The connectors 341a, 341b, 342a, 342b, 343a, 343b, 343c and 343d may suitably be connected to the input contacts of the switches 331, 332, . . . 338 via wires and/or jumpers. However, in other embodiments, printed circuit board conductors or the like may be used.

The first voice coil 312 is connected between the output contact 331d of the switch element 331 and the output contact 332d of the switch element 332. The second voice coil 314 is connected between the output contact 333d of the switch element 333 and the output contact 334d of the switch element 334. The third voice coil 316 is connected between the output contact 335d of the switch element 335 and the output contact 336d of the switch element 336. The fourth voice coil 318 is connected between the output contact 337d of the switch element 337 and the output contact 338d of the switch element 338.

In the embodiment described herein, the connectors 341a and 341b are to be connected when the subwoofer containing the arrangement 302 is used in a 70 or 100 volt distributed audio system, the connectors 342a and 342b are to be used when the subwoofer containing the arrangement 302 is to be connected in a 4 ohms monaural configuration, and the connectors 343a, 343b, 343c, and 343d are used for an 8 ohms stereo configuration. Each of the above-described configurations associated with one of the three positions of the switch 320.

In general, FIGS. 4a, 4b and 4c show these three configurations of the voice coil arrangement 302 in an individual manner. Each of FIGS. 4a, 4b and 4c shows only the portion of the interconnection circuit 321 that corresponds to the configuration associated with the switch position being depicted. Thus, for example, FIG. 4a shows the switch 320 in a first position in which the first input contacts 331a, 332a, 333a. . . 338a are all connected to the output contacts 331d, 332d, . . . 338d, FIG. 4b shows the switch 320 in a second position in which the second input contacts 331b, 332b, . . . 338b are all connected to the output contacts 331d, 332d, . . . 338d, and FIG. 4c shows the switch 320 in a third position in which the third input contacts 331c, 332c, . . . 338c are all connected to the output contacts 331d, 332d, . . . 338d. Accordingly, as each configuration is discussed below, it is discussed in connection with FIG. 3 and a corresponding one of FIGS. 4a, 4b, and 4c.

The first configuration of the voice coil arrangement 302, shown in FIG. 3a, is configured to accommodate a 70 or 100 volt distributed audio system. To this end, the connector 341a is coupled to the input contact 331a of switch 331 and the connector 341b is coupled to the input contact 338a of switch 338. The input contact 332a of switch 332 is connected to input contact 333a of switch 333, the input contact 334a of switch 334 is connected to input contact 335a of switch 335, and the input contact 336a of switch 336 is connected to input contact 337a of switch 337. As a consequence, the four coils 312, 314, 316 and 318 are series connected between the connector 341a and 341b. Because the four 16 ohms coils 312, 314, 316 and 318 are connected in series, the total impedance of the arrangement 302 in the first configuration is 64 ohms.

The second configuration, shown in FIG. 3b, is configured as a monaural 4 ohms subwoofer for a normal consumer stereo system (well below 50 volts). To this end, the connector 342a is coupled to the input contact 331b of switch 331 and the connector 342b is coupled to the input contact 332b of switch 332. The input contact 331b is further connected to the input contacts 333b, 335b and 337b. Similarly, the input contact 332b is further connected to the input contacts 334b, 336b and 338b. As a consequence, the four coils 312, 314, 316 and 318 are parallel connected between the connector 342a and 342b. Because the four 16 ohms coils 312, 314, 316 and 318 are connected in parallel, the total impedance of the arrangement 302 in the second configuration is 4 ohms.

The third configuration, shown in FIG. 3c, is configured as a stereo 8 ohms per side subwoofer. To this end, the connector 343a is coupled to the input contact 331c of switch 331, the connector 343b is coupled to the input contact 332c of switch 332, the connector 343c is coupled to the input contact 335c of switch 335, and the connector 343d is coupled to the input contact 336c of switch 336. The input contact 331c is further connected to the input contact 333c, the input contact 332c is further connected to the input contact 334c, the input contact 335c is further connected to the input contact 337c, and the input contact 336c is further connected to the input contact 338c. As a consequence, the two coils 312 and 314 are parallel connected between the connectors 343a and 343b, and the two coils 316 and 318 are parallel connected between the connectors 343c and 343d. Accordingly, the arrangement 302 has two sets of connectors connected to the speaker, and the speaker exhibits 8 ohms impedance across each of the sets of connectors.

In operation, a subwoofer (or other speaker) having the arrangement 302 described above is configured for different applications by 1) turning the switch 320 to the position corresponding to the select configuration and then 2) wiring the speaker conductors (e.g. conductor 116 of FIG. 1) to the appropriate set of connectors corresponding to the select configuration. Ideally, ample labels are made available to facilitate matching connectors 341a, 341b, 342a, 342b, 343a, 343b, 343c and 343d and positions of the switch 320 with the corresponding configuration.

Thus, the use of manually switchable voice coils in the subwoofer voice coil arrangement of FIGS. 3, 4a, 4b, and 4c allows a single subwoofer design to be used in three drastically different applications. As a result, the cost associated with providing a specially designed subwoofer for distributed systems is eliminated.

As discussed above, one advantage of the switching voice coil arrangement of embodiments of the arrangement is the elimination of a transformer to allow high voltage to be used on normal 4 or 8 ohms speakers. An additional advantage to eliminating the need for a transformer in the embodiment of FIG. 3 is that the low frequencies typically projected by subwoofers can experience distortion and/or other degradation when the audio signal is passed through a transformer. Accordingly, by eliminating the transformer while still retaining the ability to be used in various applications, the subwoofer that employs the arrangement 302 offers greater flexibility with improved sound quality.

Referring again to the various embodiments discussed herein, it will be appreciated that one advantage of the invention arises from using switchable terminals (i.e. switches, jumpers, other readily manually adjustable connections) to either adjust volume level, or configure the speaker for different applications. It will be appreciated that the terminal connection equipment may be in multiple pieces, but that such pieces would still be mounted on the same frame or housing as the remaining elements of the speaker. As a consequence, the installer or consumer may perform the adjustment directly on the speaker assembly.

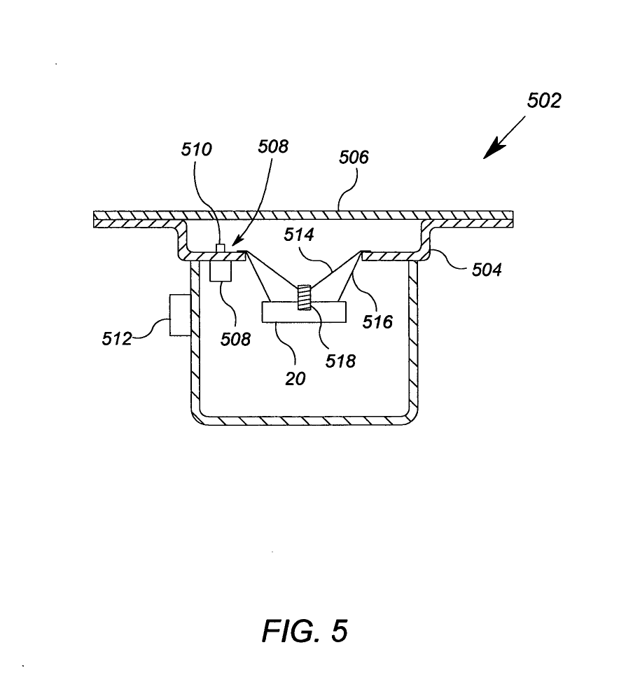

FIG. 5 shows an exemplary physical structure that may be used for any of the devices discussed in FIG. 1, 2 or 3. The speaker assembly 502 of FIG. 4 is intended to be installed in ceiling or wall structure of a facility. The assembly 502 includes a baffle (plastic or metal) 504, a grill 506, a first terminal element 508 (for manual switch 510), a second terminal element 512 (for wiring), a speaker cone 514, a speaker frame 516 (metal or plastic) a voice coil and core assembly 518 and a spider 520. The assembly 502 further includes a sound chamber structure 522. It will be appreciated that the advantages of the invention may readily be obtained in different physical assemblies, including those not designed for installation into a ceiling or wall, and including those without enclosed sound chambers. Without a sound chamber, the terminal elements may be connected to the baffles or any other frame or housing element particular to the implementation.

The above described embodiments are merely exemplary. Those of ordinary skill in the art may readily devise their own implementations that incorporate the principles of the present invention and fall within the spirit and scope thereof. One alternative would be a 70 volt stereo system that employed speakers having a non-switchable high impedance (having a value approximately between 250-500 ohms) to eliminate the need for a transformer while sacrificing some of the versatility and adjustability provided by the embodiments of FIGS. 1, 2 and 3. Other embodiments employ a separate tweeter that includes a transformer, which is small an inexpensive, in combination with a high impedance woofer or other non-tweeter general purpose speaker. Such a device would include common cross over circuitry to isolate the tweeter from high power low frequency signals.

1. A voice coil arrangement for a loudspeaker, comprising:
a plurality of voice coils operably supported on the loudspeaker;
a switchable terminal operable to selectively connect the plurality of voice coils in a plurality of configurations, each configuration defining one of a plurality of impedances for the plurality of voice coils.

2. The voice coil arrangement of claim 1 wherein the switchable terminal is further operable to at least selectively connect at least two voice coils in series.

3. The voice coil arrangement of claim 1 wherein the switchable terminal is further operable to at least selectively connect at least two voice coils in parallel.

4. The voice coil arrangement of claim 1 wherein the plurality of voice coils consists of four voice coils.

5. The voice coil arrangement of claim 1 wherein the switchable terminal includes a first setting in which at least two of the voice coils are connected in series and a second setting in which at least two of the voice coils are connected in parallel.

6. The voice coil arrangement of claim 1 wherein the switchable terminal includes at least one manually-operated switch.

7. The voice coil arrangement of claim 1 wherein the switchable terminal includes one or more movable jumper connections.

8. The voice coil arrangement of claim 1 wherein the switchable terminal includes at least two input terminals configured to be connected to a source of electrical audio signals.

9. The voice coil arrangement of claim 1 wherein at least two of the voice coils comprise two layer voice coils.

10. A loudspeaker, comprising
a diaphragm;
a magnetic core;
a plurality of coils in a flux communicating relationship with the magnetic core; the plurality of coils connected to a terminal, the terminal manually configurable to selectively connect the plurality of coils in a plurality of configurations, each of the plurality of configurations having one of a plurality of impedances.

11. The loudspeaker of claim 10 wherein the terminal is further manually configurable to at least selectively connect at least two voice coils in series.

12. The loudspeaker of claim 10 wherein the terminal is further manually configurable to at least selectively connect at least two voice coils in parallel.

13. The loudspeaker of claim 10 wherein the plurality of voice coils consists of four voice coils.

14. The loudspeaker of claim 13 wherein the terminal comprises a switch having at least two positions and a plurality of switching elements connected to switch in unison.

15. The loudspeaker of claim 14 wherein a first position of the switch corresponds to a series connection of the four voice coils.

16. The loudspeaker of claim 15 wherein a second position of the switch corresponds to a parallel connection of the four voice coils.

17. The loudspeaker of claim 16 wherein each of the four voice coils has an impedance of substantially 16 ohms.

18. A distributed audio system comprising:
an audio amplifier having an electrical audio output having an average voltage level of at least about 50 volts;
a plurality of speakers, each speaker having a voice coil arrangement having a characteristic impedance of at least 64 ohms

19. The distributed audio system of claim 18 wherein at least one speaker has a voice coil arrangement having a single voice coil.

20. The distributed audio system of claim 18 wherein at least one speaker has a voice coil arrangement having a plurality of voice coils.
